(19) United States
(12) Patent Application Publication
(10) Pub. No.: US 2010/0149789 A1
(43) Pub. Date: Jun. 17, 2010

(54) LIGHTING DEVICE FOR DISPLAY DEVICE AND DISPLAY DEVICE

(75) Inventor: Masahiro Arai, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/594,015

(22) PCT Filed: Dec. 17, 2007
(86) PCT No.: PCT/JP2007/074206

§ 371 Date: Sep. 30, 2009

(30) Foreign Application Priority Data
Apr. 20, 2007 (JP) 2007-111610

(51) Int. Cl. G02F 1/13357

(52) U.S. Cl. 362/97.2; 362/97.1

(57) ABSTRACT

A lighting device for a display device includes a light source and a chassis arranged to cover the light source. The chassis includes one of a groove section and an opening section located directly below the light source. The one of a groove section and an opening section has a relatively small width at an area directly below a low voltage area of the light source, compared to at an area directly below a high voltage area of the light source.

### BACKGROUND OF THE INVENTION

1. Field of the Invention

The present invention relates to a lighting device for a display device and a display device using the same.

2. Description of the Related Art

In a display device having non-luminous optical elements as typified by a liquid crystal display device, a backlight device is provided on the backside of a display panel such as a liquid crystal panel, so as to illuminate the display panel (as shown in JP-A-2006-66360, for example).

JP-A-2006-66360 discloses a backlight assembly that includes lamps and a housing member for holding the lamps. In the backlight assembly thus including lamps and a housing member for holding the lamps, beat tones may be generated during dimming control of the lamps, due to the second and third harmonics of a dimming control frequency.

There are various theories as to how the beat tones are generated. For example, one of the theories suggests involvement of current leakage from the lamps to the housing member. That is, the beat tones may be due to vibration of the housing member caused by leakage current from the lamps.

JP-A-2006-66360 discloses that recessed portions or outwardly bulging portions corresponding to the lamps are formed on the housing member in order to prevent current leakage between the lamps and the housing member. This construction may be partly effective as a measure for beat tones. However, the strength of the housing member, or specifically, the strength against torsional stress may be significantly reduced, because the recessed (or bulging) portions having a constant width larger than the lamp diameter are arranged to extend over the entire bottom surface of the housing member (or chassis). Further, the wide recessed portions, thus extending over the entire bottom surface of the housing member, may cause difficulty in mounting of various components at the time of assembly of the device.

### SUMMARY OF THE INVENTION

In view of the foregoing circumstances, preferred embodiments of the present invention provide a lighting device for a display device having a simple construction capable of preventing or suppressing beat tones generated on a housing member (or chassis) that holds lamps (or light sources), while maintaining the sufficient strength of the housing member (or chassis). In addition, preferred embodiments of the present invention provide a high-quality and highly-reliable display device using the lighting device.

A lighting device for a display device, according to a preferred embodiment of the present invention, includes a light source and a chassis arranged to cover the light source, in which the chassis includes one of a groove section and an opening section located directly below the light source. The one of a groove section and an opening section has a relatively small width at an area directly below a low voltage area of the light source, compared to at an area directly below a high voltage area of the light source. The explanation for a groove section and an opening section is that the groove section is a bottomed recessed section while the opening section is a bottomless hole section.

The inventor of the present application has repeatedly considered measures for beat tones, and consequently the beat tones can be prevented or suppressed when a groove section or an opening section is provided to have a relatively large width at an area of the chassis directly below a high voltage area of the light source and to have a relatively small width at an area of the chassis directly below a low voltage area. This may be due to major reduction of current leakage from the light source to the chassis. That is, when a groove section or an opening section is thus provided, the distance between the light source and the chassis can be large (particularly, infinitely large in the case of the opening section). Accordingly, the leakage current may be substantially eliminated, which is expressed by the following formula (1):

I=2πfεCV=2πfε(S/d)V formula (1)

where “I” is the amount of leakage current, “C” is the stray capacitance, “V” is the potential difference between the light source and the chassis, “S” is the area of the chassis, and “d” is the distance between the light source and the chassis.

Further, the groove section or the opening section has a relatively large width at an area prone to beat tones, i.e., at an area directly below the high voltage area, so that an area where the distance between the light source and the chassis is large or infinitely large (i.e., an area proportional to the width of the groove section or the opening section) is provided to be large in size. Thereby, beat tones can be effectively eliminated. On the other hand, at an area less prone to beat tones or at an area directly below the low voltage area, the leakage current is originally small in amount, and therefore the beat tones can be adequately eliminated even though the groove section or the opening section has a relatively small width. When the groove section or the opening section thus includes an area having a relatively small width, strength degradation of the chassis can be suppressed, compared to providing a groove section or an opening section simply having a width that is equal to the width thereof at the area directly below the high voltage area.

As indicated by the formula (I), the opening section is more effective for elimination of beat tones in comparison with the groove section, because of provision of the infinitely large distance between the light source and the chassis as described above. However, the opening section increases strength reduction of the chassis. In contrast to the opening section, the groove section enables securement of sufficient strength. Therefore, in view of generation status of beat tones and ratio of a groove or opening area to the entire chassis, the present invention can be embodied so as to include selected one of a groove section and an opening section according to a preferred embodiment of the present invention, or alternatively, a combination thereof.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view showing the general construction of a liquid crystal display device according to a preferred embodiment 1 of the present invention.

FIG. 2 is a sectional view of the liquid crystal display device shown in FIG. 1.

FIG. 3 is a plan view showing the general construction of a backlight chassis included in the liquid crystal display device shown in FIG. 1.

FIG. 4 is an exploded perspective view showing the general construction of a modification of the liquid crystal display device according to the preferred embodiment 1.

FIG. 5 is a plan view showing the general construction of a backlight chassis included as the modification in the liquid crystal display device shown in FIG. 4.

FIG. 6 is an exploded perspective view showing the general construction of another modification of the liquid crystal display device according to the preferred embodiment 1.

FIG. 7 is a plan view showing the general construction of a backlight chassis included as the modification in the liquid crystal display device shown in FIG. 6.

FIG. 8 is a plan view showing the general construction of a modification of the backlight chassis included in the liquid crystal display device according to the preferred embodiment 1.

FIG. 9 is an exploded perspective view showing the general construction of a liquid crystal display device according to a preferred embodiment 2 of the present invention.

FIG. 10 is a sectional view of the liquid crystal display device shown in FIG. 9.

FIG. 11 is a plan view showing the general construction of a backlight chassis included in the liquid crystal display device shown in FIG. 9.

FIG. 12 is a perspective view separately showing a sheet and the like to be attached to the backlight chassis of the liquid crystal display device shown in FIG. 9.

FIG. 13 is an exploded perspective view showing the general construction of a modification of the liquid crystal display device according to the preferred embodiment 2.

FIG. 14 is a plan view showing the general construction of a backlight chassis included as the modification in the liquid crystal display device shown in FIG. 13.

FIG. 15 is an exploded perspective view showing the general construction of another modification of the liquid crystal display device according to the preferred embodiment 2.

FIG. 16 is a plan view showing the general construction of a backlight chassis included as the modification in the liquid crystal display device shown in FIG. 15.

FIG. 17 is a plan view showing the general construction of a modification of the backlight chassis included in the liquid crystal display device according to the preferred embodiment 2.

FIG. 18 is an explanatory diagram showing a driving scheme for cold cathode tubes, which is applied to the liquid crystal display device shown in FIG. 1 or 9.

### DETAILED DESCRIPTION OF THE PREFERRED EMBODIMENTS

### Preferred Embodiment 1

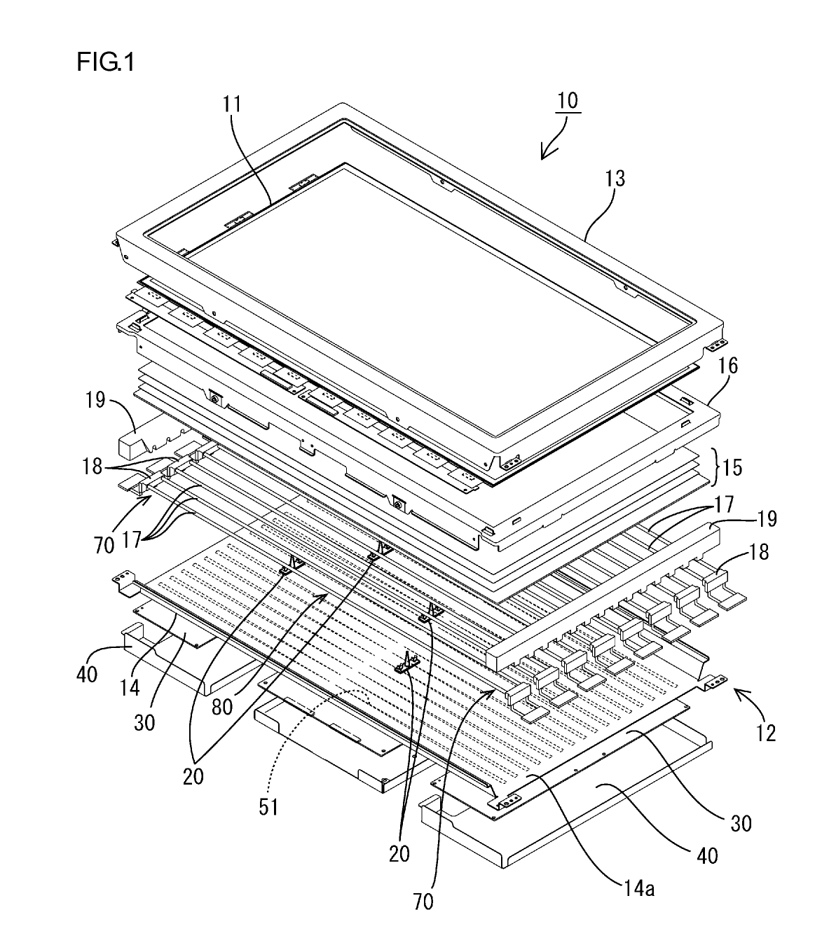

A preferred embodiment 1 of the present invention will be explained with reference to FIGS. 1 to 3.

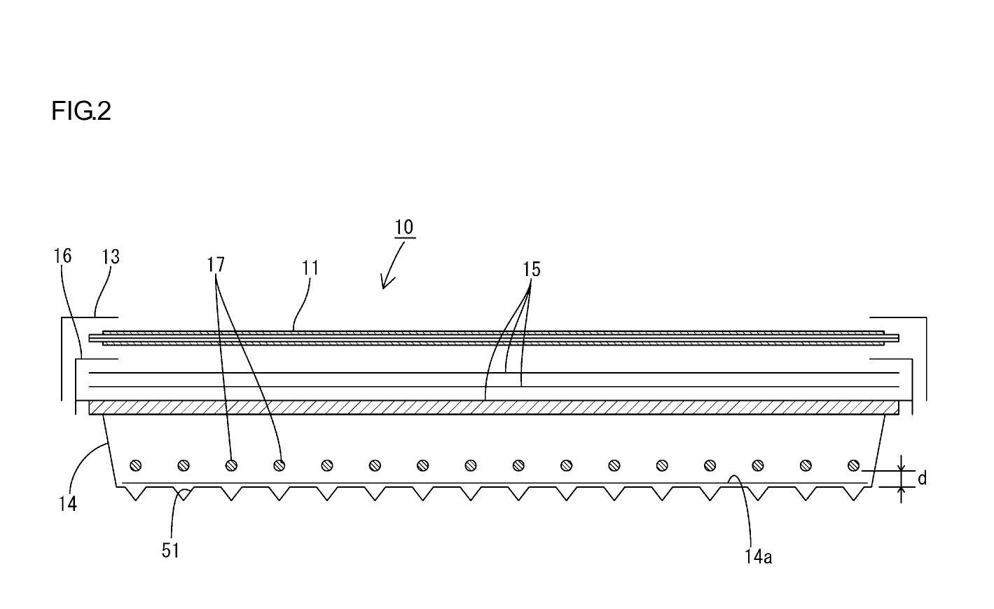

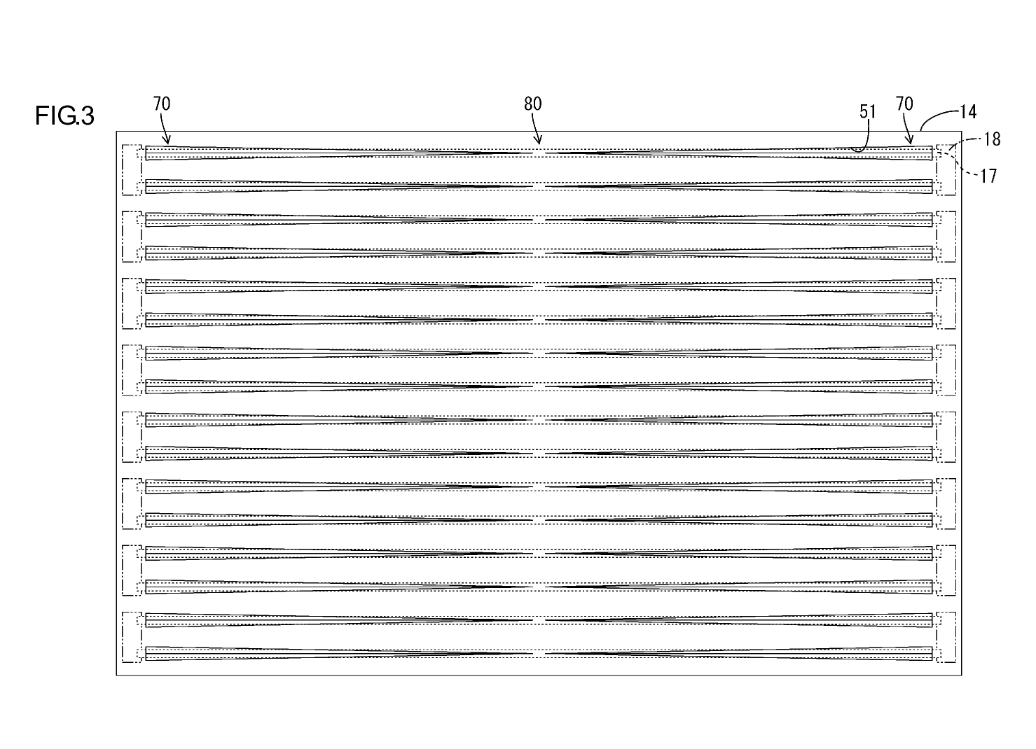

FIG. 1 is an exploded perspective view showing the general construction of a liquid crystal display device according to the present preferred embodiment. FIG. 2 is a sectional view showing the general construction of the liquid crystal display device. FIG. 3 is a plan view showing the general construction of a backlight chassis (chassis).

The general construction of the liquid crystal display device (display device) 10 according to the present preferred embodiment will be explained first. Referring to FIGS. 1 and 2, the liquid crystal display device 10 includes a liquid crystal panel 11 having a rectangular shape, and a backlight device (lighting device for a display device) 12 as an external light source, which are integrally held by a bezel 13 or the like. The liquid crystal panel 11 includes a pair of glass substrates, which are attached to each other so as to face each other while a gap of a predetermined size is kept therebetween. Liquid crystal is sealed between the glass substrates. On one of the glass substrates, components such as switching elements (e.g., TFTs) connected to source wiring lines and gate wiring lines running at right angles to each other, and pixel electrodes connected to the switching elements are provided. On the other of the glass substrates, components such as a counter electrode and a color filter having R, G, and B color sections arranged in a predetermined pattern are provided.

Next, the backlight device 12 will be explained. The backlight device 12 is a so-called direct-light type backlight device that includes a plurality of linear light sources (e.g., cold cathode tubes (light sources) 17 as high-pressure discharge tubes, in the present preferred embodiment), which are positioned directly below the back surface of the liquid crystal panel 11 (i.e., the panel surface on the opposite side of the display side), and are arranged along the panel surface.

The backlight device 12 includes a backlight chassis (chassis) 14 having a substantially box-like shape with an opening on its upper side, and a plurality of optical members 15 (e.g., a diffuser plate, a diffusing sheet, a lens sheet and an optical sheet, in order from the lower side of the figure) which are arranged to cover in the opening of the backlight chassis 14. Further included is a frame 16 arranged to hold the optical members 15 on the backlight chassis 14. The backlight chassis 14 contains the cold cathode tubes 17, rubber holders 18 arranged to hold the end portions of the cold cathode tubes 17, lamp holders 19 arranged to collectively cover the cold cathode tubes 17 and the holders 18, and lamp clips 20 arranged to mount and hold the cold cathode tubes 17 on the backlight chassis 14. Note that the optical member 15 side of the cold cathode tubes 17 corresponds to the light emitting side of the backlight device 12.

The backlight chassis 14 preferably includes a metallic plate. A light reflecting sheet 14a is provided on the inner surface side (light source side) of the backlight chassis 14, which defines a light reflecting surface. The backlight chassis 14 thus includes the light reflecting sheet 14a, and thereby the light from the cold cathode tubes 17 can be reflected to the optical members 15 such as the diffuser plate (hereinafter, sometimes referred to as “the diffuser plate 15 and the like”). The light reflecting sheet 14a can be formed of a resin sheet having light reflectivity, for example.

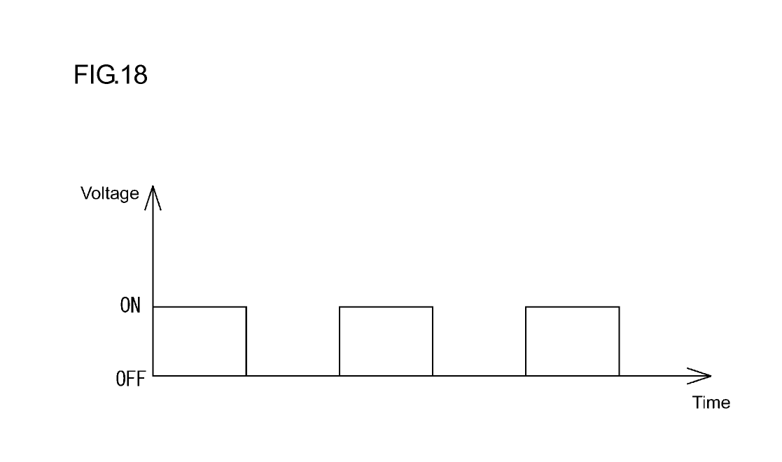

Inverter boards 30 for supplying drive voltage to the cold cathode tubes 17 are mounted to the backlight chassis 14, or specifically, mounted on the opposite side of the cold cathode tubes 17 (i.e., on the opposite side of the light emitting surface). Each inverter board 30 includes an inverter circuit that generates a high-frequency voltage for lighting the cold cathode tubes 17. Specifically, in the present preferred embodiment, the inverter circuits are connected to both end portions of each cold cathode tube 17, and therefore the both end portions of the cold cathode tube 17 are subjected to high voltage during lighting. Referring to FIG. 18, in the present preferred embodiment, the cold cathode tubes 17 are driven by pulse-width modulation (PWM), for example. Thereby, the dimming control is performed in a predetermined cycle.

Each of the cold cathode tubes 17, contained in the backlight chassis 14, preferably has an elongated tubular shape (or a linear shape). A number (e.g., sixteen in FIG. 1) of cold cathode tubes 17 are contained in the backlight chassis 14 so that the longitudinal direction (or axial direction) thereof conforms with the long-side direction of the backlight chassis 14.

On the bottom surface of the backlight chassis 14 or directly below the cold cathode tubes 17, groove sections 51 are formed to overlap with the respective cold cathode tubes 17. Referring to FIGS. 1 to 3, each groove section 51 is arranged along the axial direction of a cold cathode tube 17, and includes a pair of depressed portions each having an elongated substantially-isosceles triangular opening, which are arranged so that the vertices of isosceles triangles between two sides of equal length face each other. That is, the width of the groove section 51 decreases continuously and gradually from the end areas (or high voltage areas 70) of the cold cathode tube 17 toward the central area (or low voltage area 80).

Specifically, sixteen groove sections 51, each of which includes a pair of substantially-isosceles triangular depressed portions facing each other as described above, are arranged parallel or substantially parallel so as to correspond to the parallel-arranged respective sixteen cold cathode tubes 17, in the present preferred embodiment.

The groove sections 51 are formed by partly concaving the backlight chassis 14, so as to bulge from the backlight chassis 14 toward the opposite side of the opening side of the groove sections 51 (i.e., toward the opposite side of the light emitting surface side) (See. FIG. 2). Each groove section 51 has a ridge-shaped bottom, and the depth thereof is set to be constant in spite of varying width.

The groove sections 51 are provided on the inner side of the light reflecting sheet 14a, and therefore are shown by broken lines in FIG. 1. The groove sections 51 are made during the sheet processing of the backlight chassis 14, in the present preferred embodiment.

Next, the operational effects of the liquid crystal display device 10 according to the present preferred embodiment will be described. In the liquid crystal display device 10 of the present preferred embodiment, the chassis (backlight chassis) 14 of the backlight device 12 is formed to include groove sections 51, which have a relatively large width at areas directly below the high voltage areas 70 of the cold cathode tubes 17, and have a relatively small width at areas directly below the low voltage areas 80. According to the construction, while the strength of the chassis 14 is maintained, the chassis 14 is less likely to generate beat tones, which can be caused by its vibration.

The beat tones may be thus generated on the chassis 14 due to vibration of the chassis 14. The vibration may result from various factors, and the factors include current leakage from the cold cathode tubes 17.

The chassis 14 is formed of a conductive metal plate, and therefore a capacitor may be formed between the cold cathode tube 17 and the chassis 14. Accordingly, an ordinary construction (not including groove sections 51) may be prone to current leakage from the cold cathode tubes 17 to the chassis 14. A force acting on the chassis 14 can be generated due to the leakage current, which causes the chassis 14 to vibrate resulting in beat tones. Particularly, in the case of pulse-width modulation, the leakage current can be periodic, and therefore a periodic force acts on the chassis 14 so as to generate beat tones.

In contrast, according to the present preferred embodiment, the groove sections 51 are provided on the chassis 14 so as to be located directly below the cold cathode tubes 17. In the construction, the distance between the cold cathode tubes 17 and the chassis 14 can be large at the groove sections 51. Consequently, the beat tones may be prevented due to suppression of leakage current that can be expressed by the following formula (1):

I=2πfεCV=2πfε(S/d)V formula (1)

where “I” is the amount of leakage current, “C” is the stray capacitance, “V” is the potential difference between the cold cathode tubes 17 and the chassis 14, “S” is the area of the chassis 14, and “d” is the distance between the cold cathode tubes 17 and the chassis 14.

Further, the groove sections 51 have a relatively large width at areas prone to beat tones, i.e., at areas directly below the high voltage areas 70, so that areas where the distance between the light sources and the chassis is large (i.e., areas proportional to the width of the groove sections 51) is provided to be large in size. Thereby, beat tones can be effectively prevented. On the other hand, at areas less prone to beat tones or at areas directly below the low voltage areas 80, the leakage current is originally small in amount, and therefore the beat tones can be adequately eliminated even though the groove sections 51 have a relatively small width. When the groove sections 51 thus include areas having a relatively small width, strength degradation of the chassis can be suppressed, compared to providing groove sections simply having a width that is equal to the width thereof at areas directly below the high voltage areas 70. Consequently, the backlight device 12 and therefore the liquid crystal display device 10 can be provided with sufficient strength for use.

In order to provide a technical measure while suppressing the strength degradation of the chassis 14, groove sections have been solely provided at areas directly below the high voltage areas 70 of the cold cathode tubes 17, by way of experiment. However, according to the construction, the beat tones cannot be adequately reduced, while the strength of the chassis 14 is maintained.

In the present preferred embodiment, specifically, the width of each groove section 51 decreases continuously and gradually from the areas directly below the high voltage areas 70 of the cold cathode tube 17 toward the area directly below the low voltage area 80.

Due to the construction thus having a continuously and gradually decreasing width, beat tones can be effectively eliminated. The high voltage side is prone to beat tones due to current leakage from the light source. However, the leakage current decreases substantially continuously toward the low voltage side. For this reason, the groove sections 51 are provided to have a width continuously decreasing from the areas directly below the high voltage areas 70 toward the areas directly below the low voltage areas 80, which can be an effective measure to suppress leakage current and thereby suppress beat tones.

Thus, the backlight device 12, and therefore the liquid crystal display device 10 having the backlight device, can be provided to have a simple construction including groove sections 51 having a smaller width at areas directly below the low voltage areas 80 of the cold cathode tubes 17 than at areas directly below the high voltage areas 70, which can prevent or suppress beat tones while the sufficient strength of the chassis 14 is maintained.

Shown above is the preferred embodiment 1 of the present invention. However, the present invention is not limited to the preferred embodiment explained in the above description made with reference to the drawings. The following preferred embodiments may be included in the technical scope of the present invention, for example.

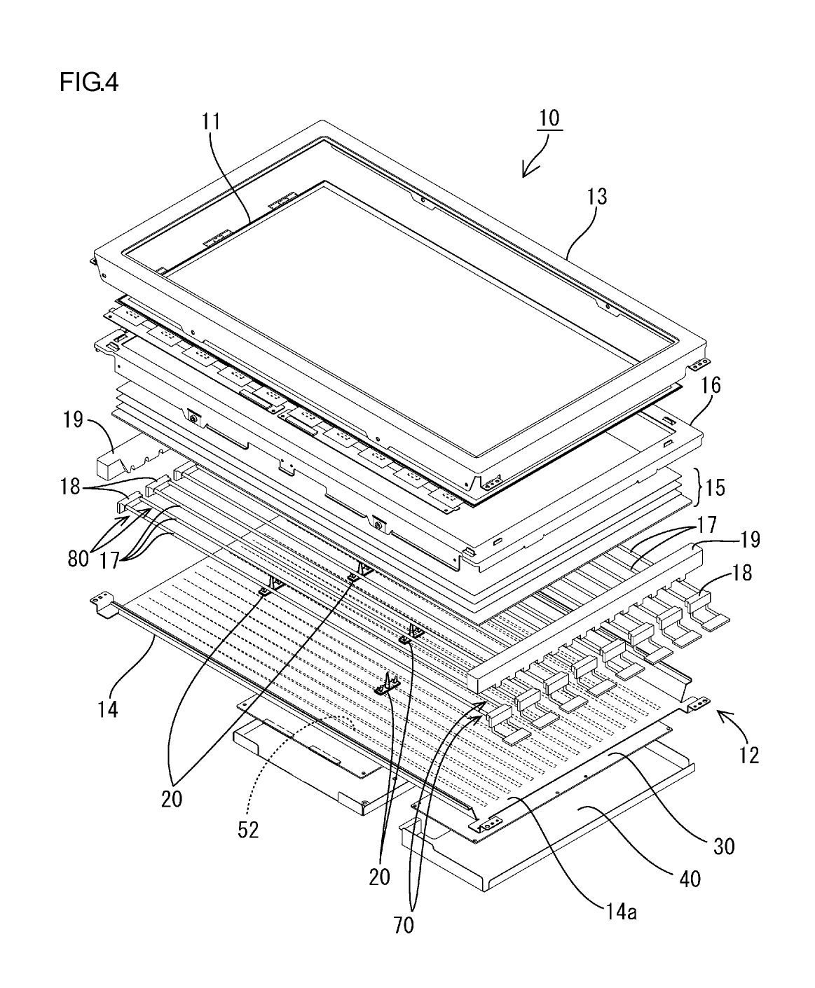

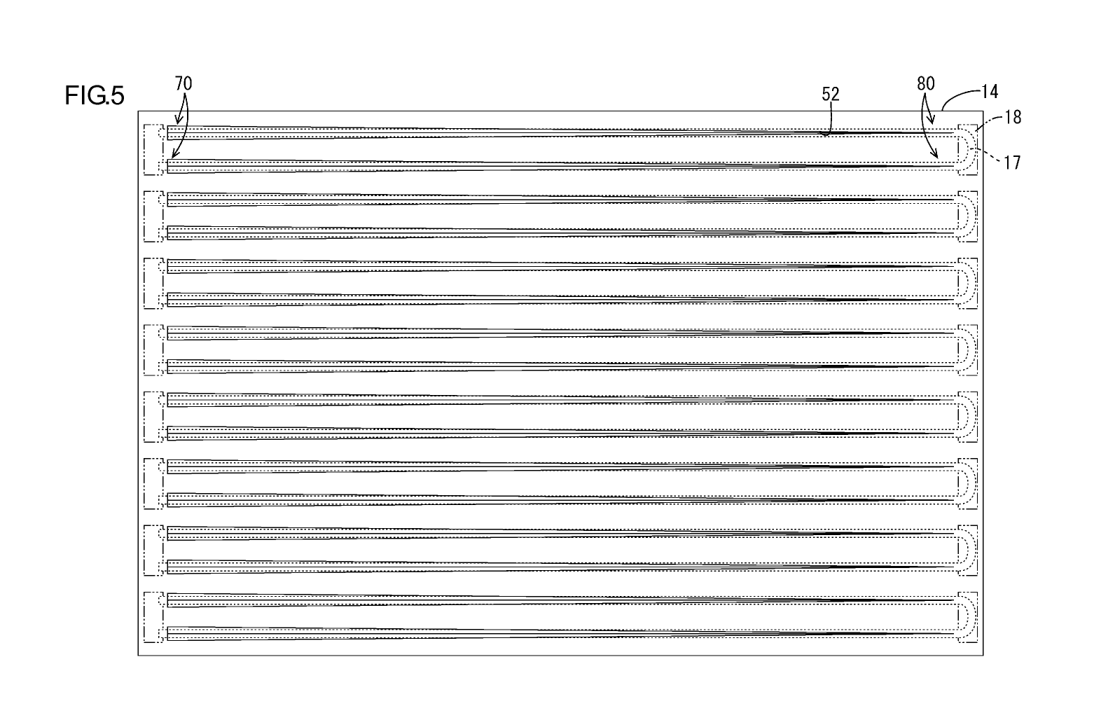

In the above preferred embodiment 1, each cold cathode tube 17 preferably has a linear shape. However, substantially U-shaped cold cathode tubes may be used as shown in FIGS. 4 and 5.

In this case, groove sections 52 can be provided to have a larger width at areas directly below two end portions of each cold cathode tube 17, which are connected to an inverter circuit and therefore are to be subjected to high voltage. Preferably, the width thereof may be set to decrease continuously and gradually along the linear portions of the cold cathode tube 17. According to the construction, groove sections 52 are not provided at areas directly below the bent portions of the cold cathode tubes 17. However, the absence of groove sections 52 will not cause failure in elimination of beat tones, because the bent portions are to be subjected to significantly low voltage.

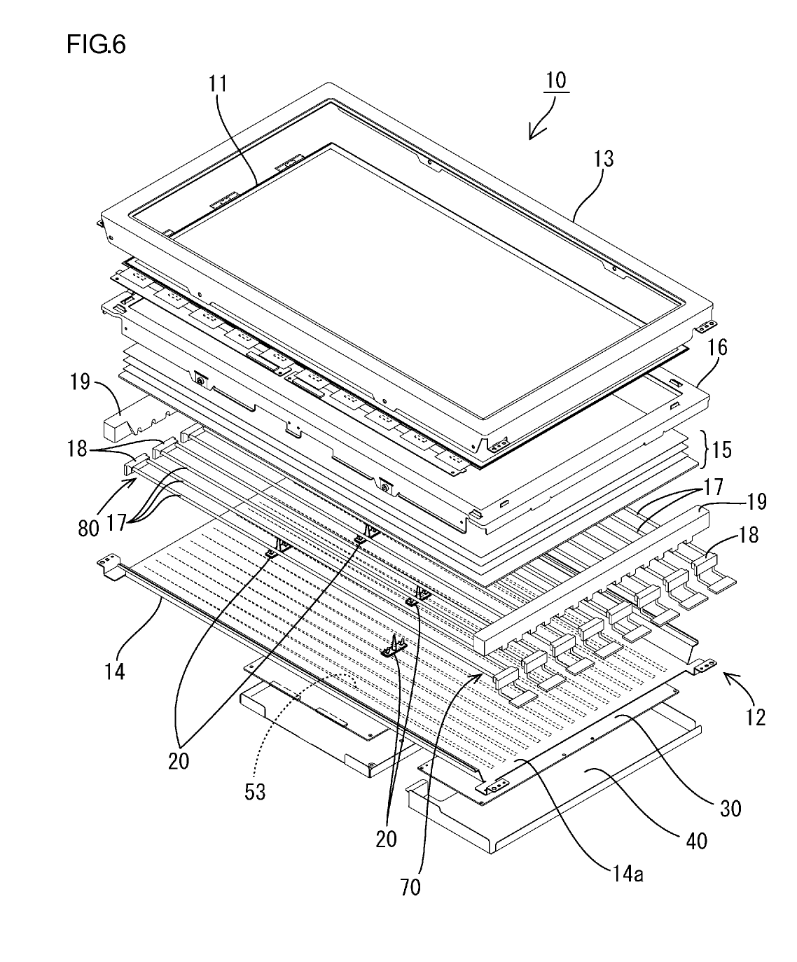

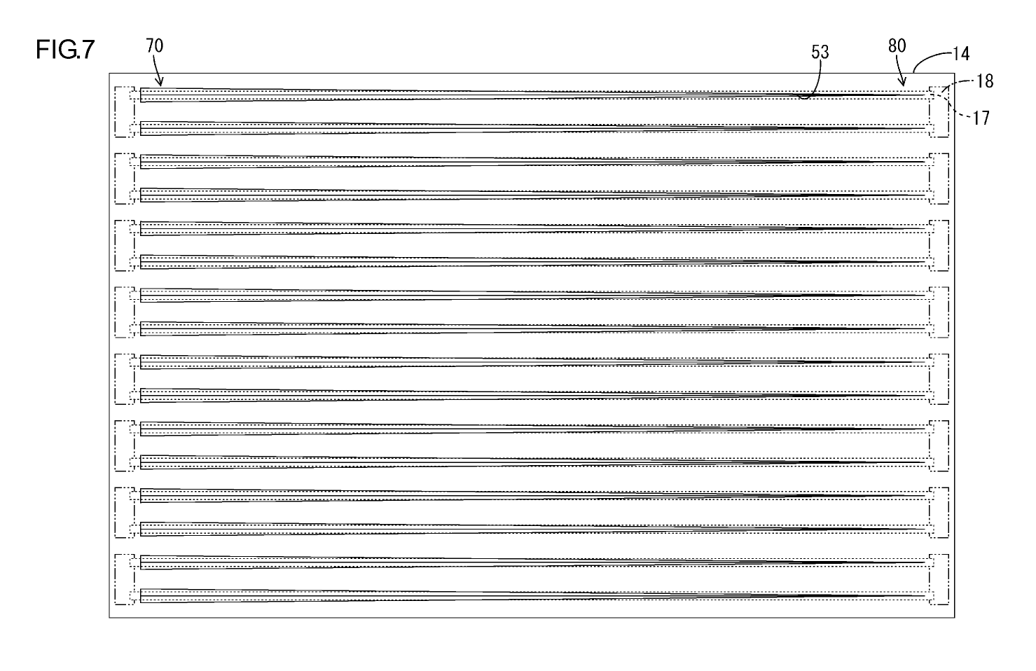

In the above preferred embodiment 1, the inverter boards 30 are provided at two ends of the backlight chassis 14, so that inverter circuits are connected to both end portions of each cold cathode tube 17. However, referring to FIGS. 6 and 7, an inverter board 30 may be provided at one end of the backlight chassis 14. That is, an inverter circuit may be connected to one end portion of each cold cathode tube 17. In this case, the one end portion of each cold cathode tube 17 is subjected to high voltage during lighting.

In this construction, groove sections 53 can be provided to have a larger width at an area directly below the end portion of each cold cathode tube 17 that is connected to the inverter circuit. Preferably, the width thereof may be set to decrease continuously and gradually toward an area directly below the other end portion of each cold cathode tube 17.

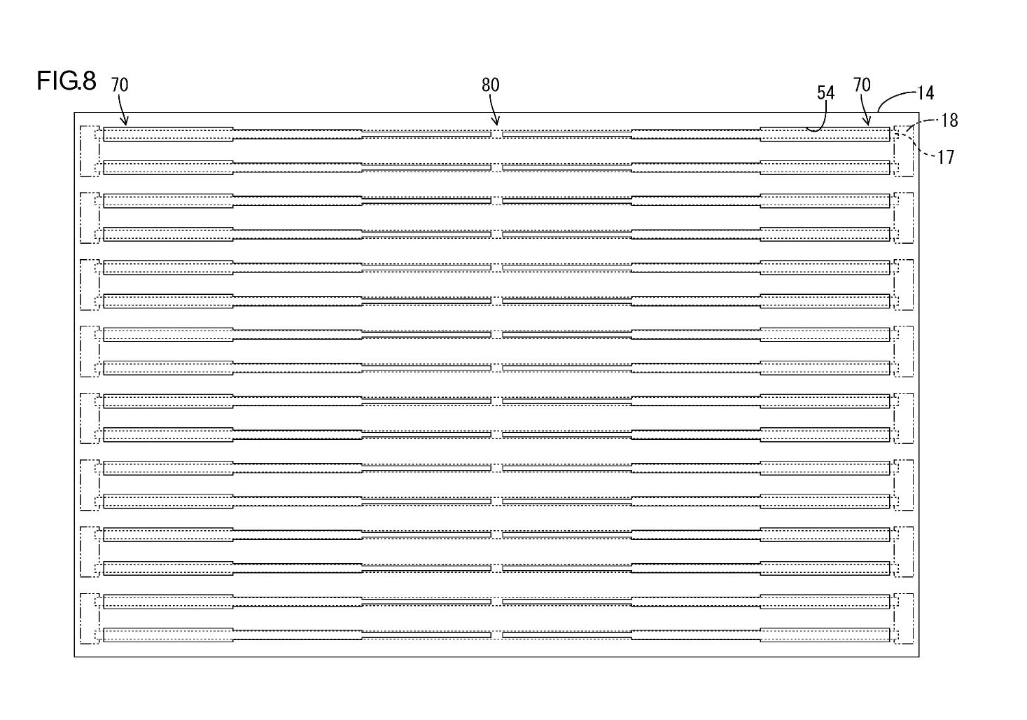

In the above preferred embodiment 1, the groove sections 51 have a width that decreases continuously and gradually from areas directly below the high voltage areas 70 of the cold cathode tubes 17 toward areas directly below the low voltage areas 80. However, groove sections 54 may be provided to have a width that decreases step-by-step and gradually from areas directly below the high voltage areas 70 of the cold cathode tubes 17 toward areas directly below the low voltage areas 80, as shown in FIG. 8.

According to the construction, beat tones can be eliminated while the strength degradation of the chassis 14 is minimized, due to the following reasons. At the high voltage areas 70 of the cold cathode tubes 17 or the areas prone to beat tones, areas where the distance between the cold cathode tubes 17 and the chassis 14 is large should be set to be large in size, i.e., the groove sections should be set to be large in width. In contrast, at the low voltage areas 80 of the cold cathode tubes 17 or the areas less prone to beat tones, the groove sections are sufficiently effective even if the width thereof is set to be small. The width of each groove section can be thus varied appropriately depending on the respective areas. Thereby, the total area of groove sections 54 is minimized, and accordingly the strength degradation of the chassis can be minimized. Consequently, the backlight device 12 and therefore the liquid crystal display device 10 can be provided with sufficient strength for use.

In the above preferred embodiment 1, the cross-sectional shape of each groove section 51 along its short axis preferably is an inverted isosceles triangle (See FIG. 2). However, the cross-sectional shape is not limited to the inverted isosceles triangle, but rather may be another shape such as a quadrangular or other polygonal shape or semicircular shape.

### Preferred Embodiment 2

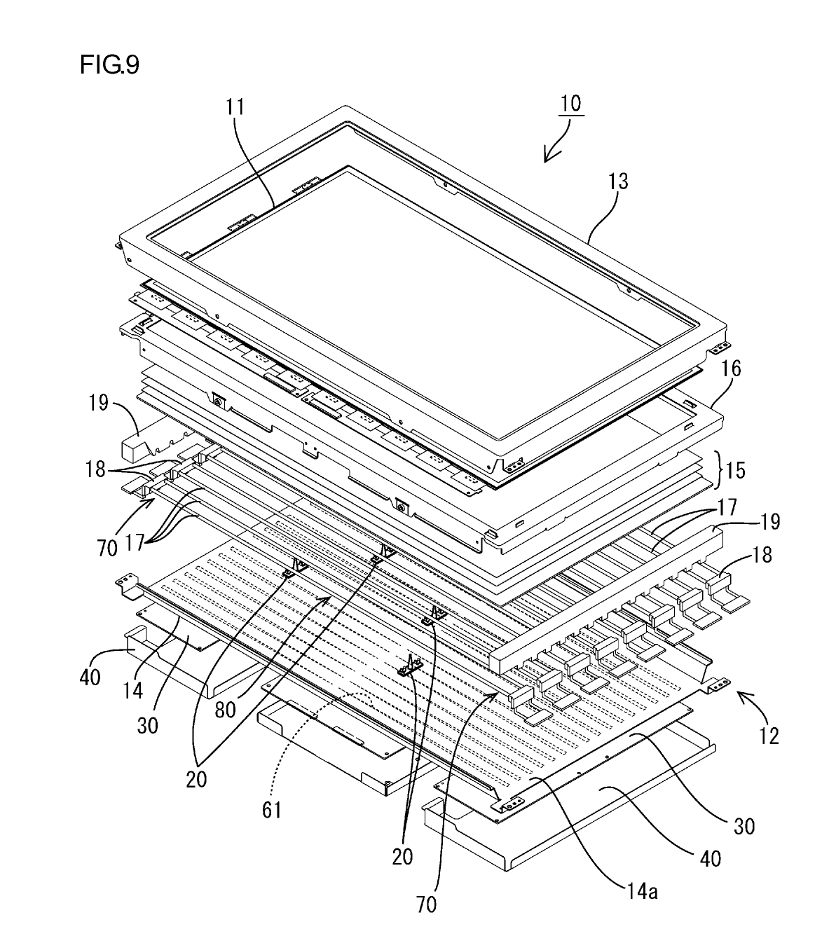

A preferred embodiment 2 of the present invention will be explained with reference to FIGS. 9 to 12. The difference from the above preferred embodiment 1 is that opening sections are provided on the chassis 14 instead of groove sections. The other constructions are similar to the above preferred embodiment. Therefore, the same components as the above preferred embodiment are designated by the same symbols, and redundant explanations are omitted.

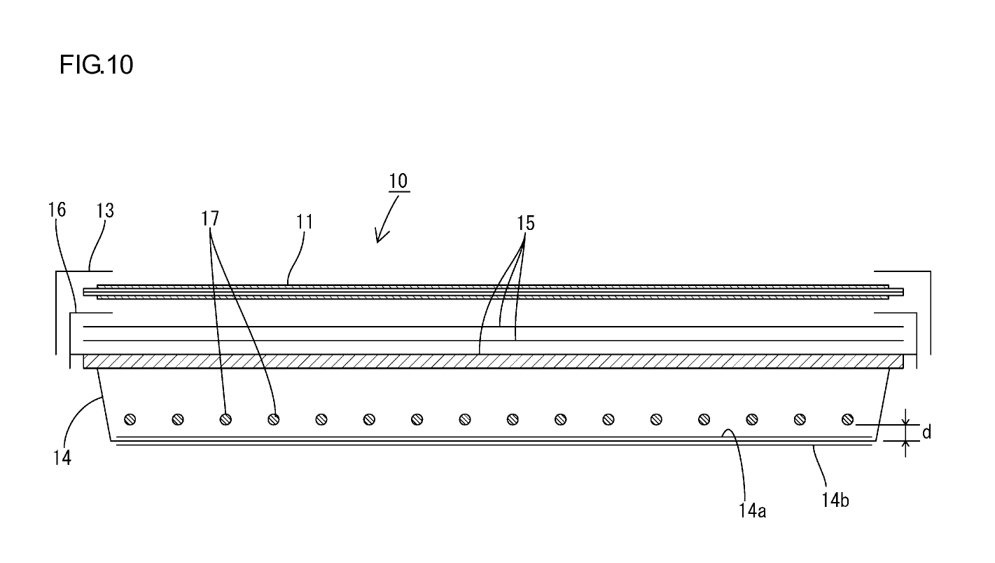

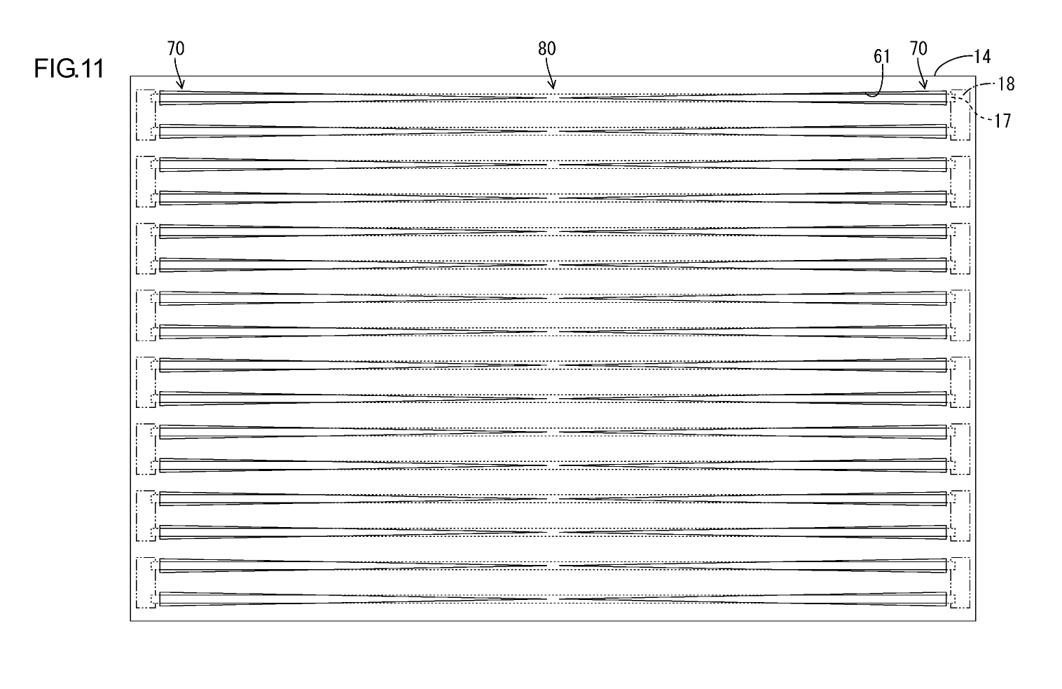

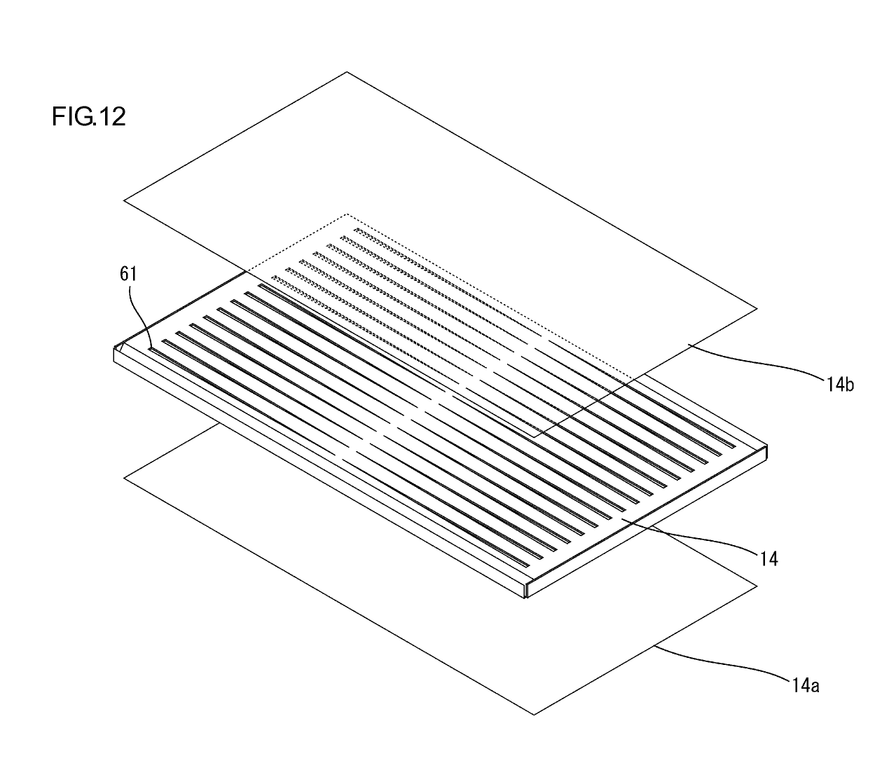

FIG. 9 is an exploded perspective view showing the general construction of a liquid crystal display device according to the present preferred embodiment. FIG. 10 is a sectional view showing the general construction of the liquid crystal display device. FIG. 11 is a plan view showing the general construction of a backlight chassis (chassis). FIG. 12 is a perspective view separately showing a sheet and the like to be attached to the backlight chassis.

Each cold cathode tube 17 preferably has an elongated tubular shape (or a linear shape), and inverter circuits are connected to both end portions thereof (See FIG. 9). Therefore, the both end sides of each cold cathode tube 17 are provided as high voltage areas 70, while the central area is provided as a low voltage area 80. Referring to FIG. 18, in the present preferred embodiment, the cold cathode tubes 17 are driven by pulse-width modulation (PWM), for example. Thereby, the dimming control is performed in a predetermined cycle.

On the other hand, the opening sections 61 are formed on the bottom surface of the backlight chassis 14 so as to be located directly below the parallel-arranged cold cathode tubes 17. Referring to FIGS. 9 and 11, each opening section 61 is arranged along the axial direction of a cold cathode tube 17, and includes a pair of elongated substantially-isosceles triangular sections, which are arranged so that the vertices of isosceles triangles between two sides of equal length face each other. That is, the width of the opening section 61 decreases continuously and gradually from the end areas (or high voltage areas 70) of the cold cathode tube 17 toward the central area (or low voltage area 80).

The opening section 61 is formed by partly removing the backlight chassis 14.

The opening sections 61 are provided on the inner side of a light reflecting sheet 14a, and therefore are shown by broken lines in FIG. 9. The opening sections 61 are made during the sheet processing of the backlight chassis 14, in the present preferred embodiment.

The light reflecting sheet 14a is provided on the inner surface side of the chassis 14 as described above, while a light blocking sheet 14b is provided on the outer surface side of the chassis 14 as shown in FIG. 12. The light blocking sheet 14b is arranged to cover at least the opening sections 61 of the chassis 14, and is bonded or screwed to the chassis 14. The light blocking sheet 14b can be formed of a polycarbonate-resin or acrylic-resin sheet as a molded piece to which lightproof coating material is applied, for example. Further preferably, the light blocking sheet 14b also has resistance to high temperatures, because the cold cathode tubes 17 generate heat.

The liquid crystal display device 10 thus constructed according to the present preferred embodiment can provide the following operational effects.

In the liquid crystal display device 10 of the present preferred embodiment, the chassis 14 of the backlight device 12 is formed to include opening sections 61, which have a relatively large width at areas directly below the high voltage areas 70 of the cold cathode tubes 17, and have a relatively small width at areas directly below the low voltage areas 80. According to the construction, the chassis 14 is further less likely to generate beat tones, which can be caused by its vibration.

The beat tones may be thus generated on the chassis 14 due to vibration of the chassis 14. The vibration may partly result from current leakage from the cold cathode tubes 17. The chassis 14 is formed of a conductive metal plate, and therefore a capacitor may be formed between the cold cathode tube 17 and the chassis 14. Accordingly, an ordinary construction (not including opening sections 61) may be prone to current leakage from the cold cathode tubes 17 to the chassis 14. A force acting on the chassis 14 can be generated due to the leakage current, which causes the chassis 14 to vibrate resulting in beat tones. Particularly, in the case of pulse-width modulation, the leakage current can be periodic, and therefore a periodic force acts on the chassis 14 so as to generate beat tones.

In contrast, according to the present preferred embodiment, the opening sections 61 are provided on the chassis 14 so as to be located directly below the cold cathode tubes 17. Thereby, the possibility of current leakage described above is minimized, and consequently beat tones can be prevented or suppressed. That is, the distance between the cold cathode tubes 17 and the chassis 14 can be infinitely large at the opening sections 61, and therefore the leakage current may be substantially eliminated, which is expressed by the following formula (1):

I=2πfεCV=2πfε(S/d)V formula (1)

where “I” is the amount of leakage current, “C” is the stray capacitance, “V” is the potential difference between the cold cathode tubes 17 and the chassis 14, “S” is the area of the chassis 14, and “d” is the distance between the cold cathode tubes 17 and the chassis 14.

Further, the opening sections 61 have a relatively large width at areas prone to beat tones, i.e., at areas directly below the high voltage areas 70, so that areas where the distance between the light sources and the chassis is infinitely large (i.e., areas proportional to the width of the opening sections 61) are provided to be large in size. Thereby, beat tones can be effectively prevented. On the other hand, at areas less prone to beat tones or at areas directly below the low voltage areas 80, the leakage current is originally small in amount, and therefore the beat tones can be adequately eliminated even though the opening sections 61 have a relatively small width. When the opening sections 61 thus include areas having a relatively small width, the total area of opening sections can be small and therefore strength degradation of the chassis can be suppressed, compared to providing opening sections simply having a width that is equal to the width thereof at areas directly below the high voltage areas. Consequently, the backlight device 12 and therefore the liquid crystal display device 10 can be provided with sufficient strength for use.

Specifically, in the present preferred embodiment, the width of each opening section 61 decreases continuously and gradually from the areas directly below the high voltage areas 70 of the cold cathode tube 17 toward the area directly below the low voltage area 80.

Due to the construction thus having a continuously and gradually decreasing width, beat tones can be effectively eliminated. The high voltage side is prone to beat tones due to current leakage from the light source. However, the leakage current decreases substantially continuously toward the low voltage side. For this reason, the opening sections 61 are provided to have a width continuously decreasing from the areas directly below the high voltage areas 70 toward the areas directly below the low voltage areas 80, which can be an effective measure to suppress leakage current and thereby suppress beat tones.

Further, the opening sections 61 provided for prevention or suppression of current leakage, as in the present preferred embodiment, enable a simple construction, which contributes to thinning the backlight device 12 and therefore to thinning the liquid crystal display device 10.

Moreover, in the present preferred embodiment, the light blocking sheet 14b is attached to the chassis 14 so as to cover the opening sections 61. Thereby, the lights passing through the opening sections 61 can be prevented or suppressed. Consequently, the quality reduction of the backlight device 12, and therefore of the liquid crystal display device 10, can be prevented or suppressed.

Thus, the backlight device 12, and therefore the liquid crystal display device 10 having the backlight device, can be provided to have a simple construction including opening sections 61 having a smaller width at areas directly below the low voltage areas 80 of the cold cathode tubes 17 than at areas directly below the high voltage areas 70, which can prevent or suppress beat tones while the sufficient strength of the chassis 14 is maintained.

Shown above is the preferred embodiment 2 of the present invention. However, the present invention is not limited to the preferred embodiment 2 explained in the above description made with reference to the drawings. The following preferred embodiments may be included in the technical scope of the present invention, for example.

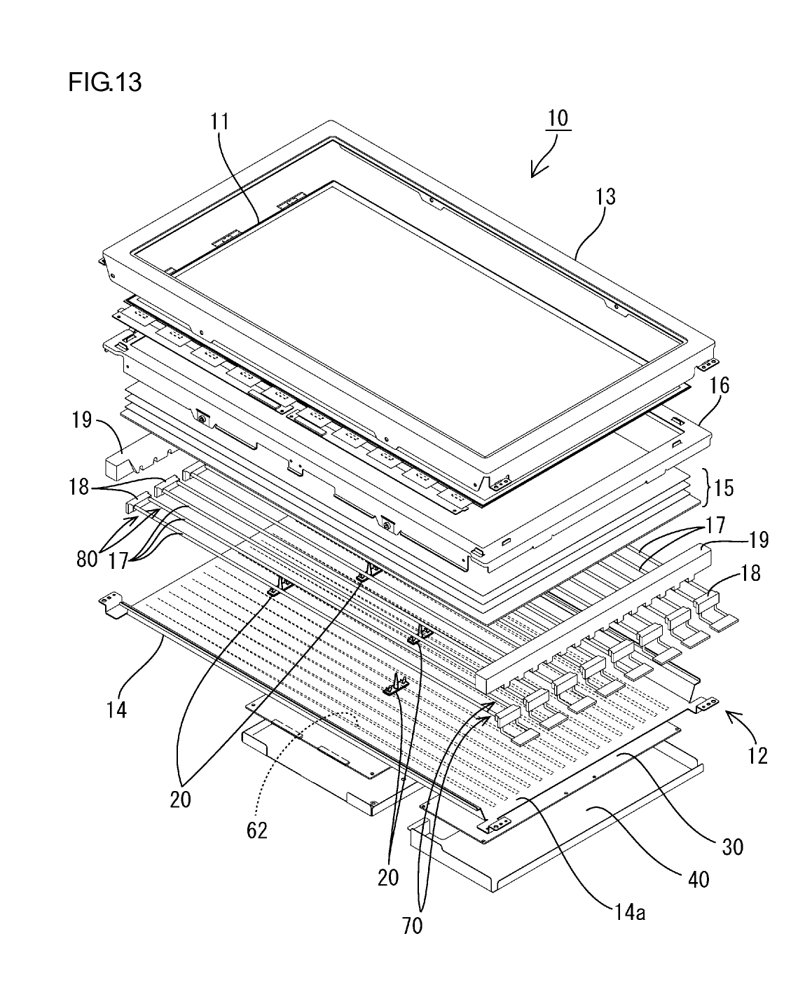

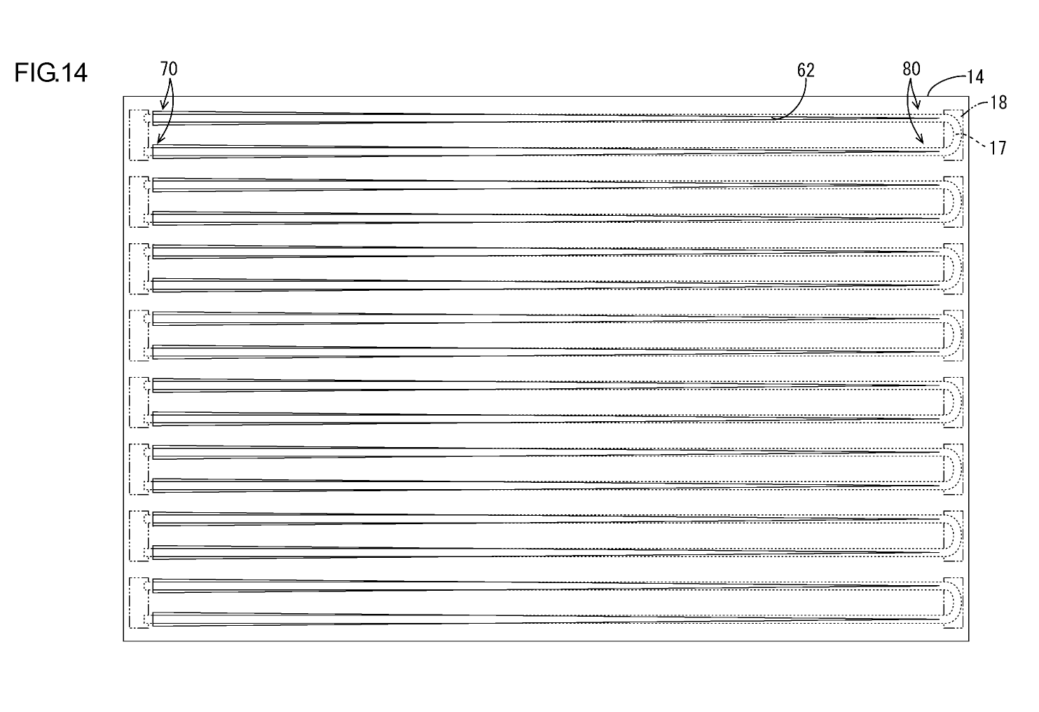

In the above preferred embodiment 2, each cold cathode tube 17 preferably has a linear shape. However, substantially U-shaped cold cathode tubes may be used as shown in FIGS. 13 and 14.

In this case, opening sections 62 can be provided to have a larger width at areas directly below two end portions of each cold cathode tube 17, which are connected to an inverter circuit and therefore are to be subjected to high voltage. Preferably, the width thereof may be set to decrease continuously and gradually along the linear portions of the cold cathode tube 17. According to the construction, opening sections 62 are not provided at areas directly below the bent portions of the cold cathode tubes 17. However, the absence of opening sections 62 will not cause failure in elimination of beat tones, because the bent portions are to be subjected to significantly low voltage.

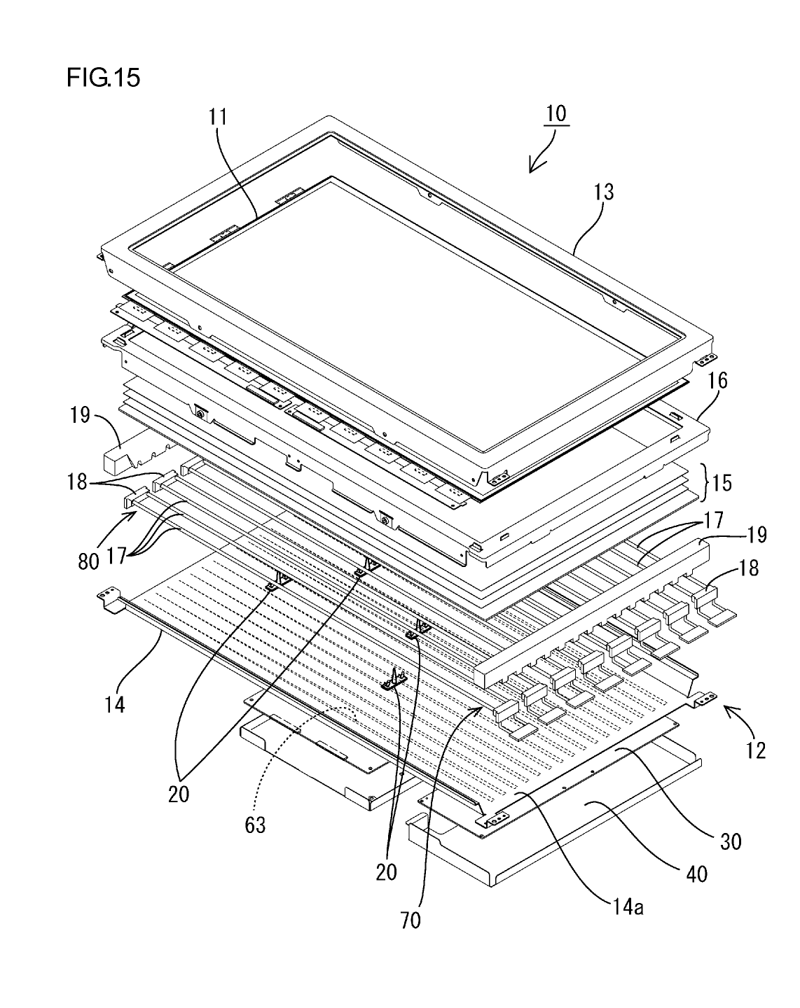

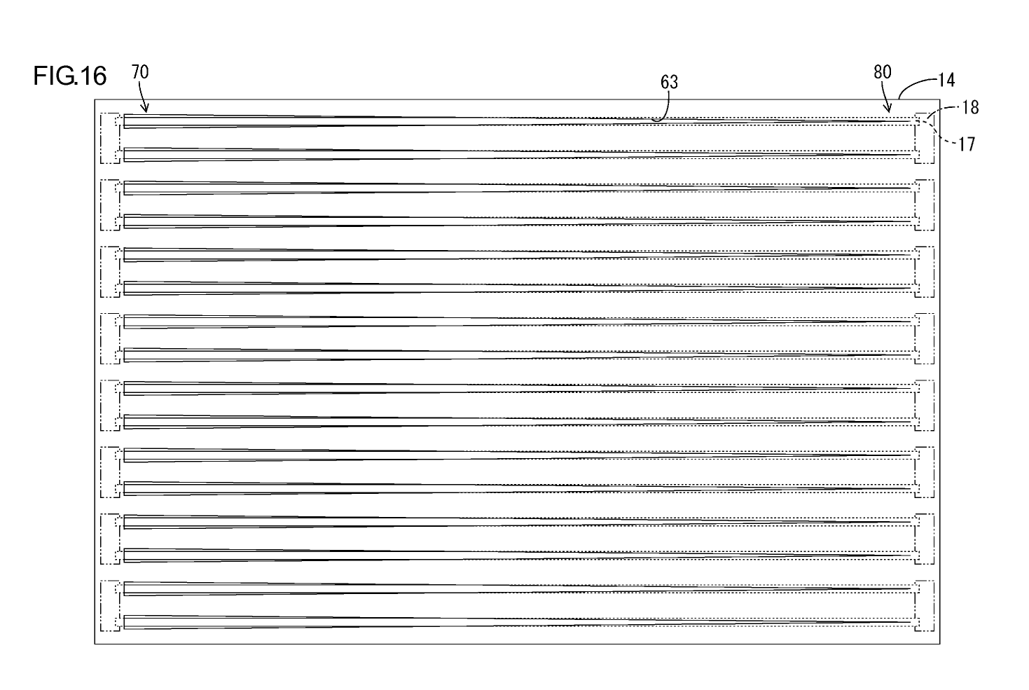

In the above preferred embodiment 2, the inverter boards 30 are provided at two ends of the backlight chassis 14, so that inverter circuits are connected to both end portions of each cold cathode tube 17. However, referring to FIGS. 15 and 16, an inverter board 30 may be provided at one end of the backlight chassis 14. That is, an inverter circuit may be connected to one end portion of each cold cathode tube 17. In this case, the one end portion of each cold cathode tube 17 is subjected to high voltage during lighting.

In the construction, opening sections 63 can be provided to have a larger width at an area directly below the end portion of each cold cathode tube 17 that is connected to the inverter circuit. Preferably, the width thereof may be set to decrease continuously and gradually toward an area directly below the other end portion of each cold cathode tube 17.

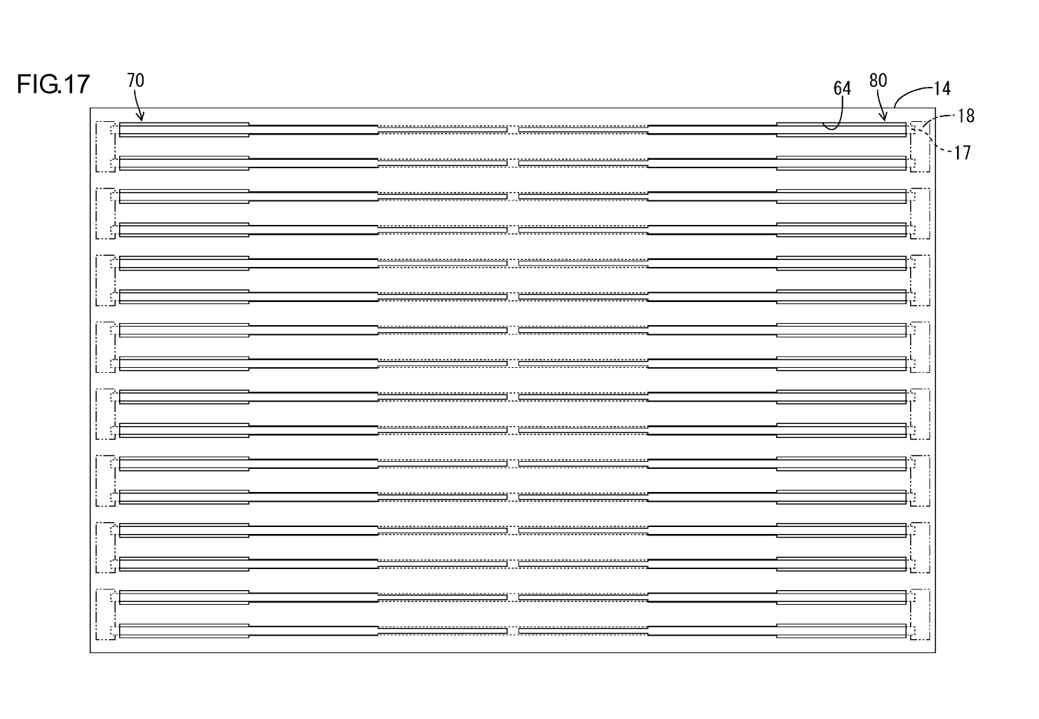

In the above preferred embodiment 2, the opening sections 61 have a width that decreases continuously and gradually from areas directly below the high voltage areas 70 of the cold cathode tubes 17 toward areas directly below the low voltage areas 80. However, opening sections 64 may have a width that decreases step-by-step and gradually from areas directly below the high voltage areas 70 of the cold cathode tubes 17 toward areas directly below the low voltage areas 80, as shown in FIG. 17.

According to the construction, beat tones can be eliminated while the strength degradation of the chassis 14 is minimized, due to the following reasons. At the high voltage areas 70 of the cold cathode tubes 17 or the areas prone to beat tones, areas where the distance between the cold cathode tubes 17 and the chassis 14 is infinitely large should be set to be large in size, i.e., the opening sections 64 should be set to be large in width. In contrast, at the low voltage areas 80 of the cold cathode tubes 17 or the areas less prone to beat tones, the opening sections 64 are sufficiently effective even if the width thereof is set to be small. The width of each opening section 64 can be thus varied appropriately depending on the respective areas. Thereby, the total area of opening sections is minimized, and consequently the backlight device 12 and therefore the liquid crystal display device 10 can be provided with sufficient strength for use.

### Other Preferred Embodiments

Shown above are the preferred embodiments 1 and 2 of the present invention. However, the present invention is not limited to the preferred embodiments explained in the above description made with reference to the drawings. The following preferred embodiments may be included in the technical scope of the present invention, for example.

In the above preferred embodiments 1 and 2, cold cathode tubes 17 are preferably used as light sources. However, the present invention can include a construction in which another type of light sources such as hot cathode tubes is used, for example.

In the above preferred embodiments 1 and 2, TFTs are preferably used as switching elements of the liquid crystal display device. However, the present invention can be applied to a liquid crystal display device that uses another type of switching elements than TFTs (e.g., thin-film diodes (TFDs)). Further, the present invention can be applied to a liquid crystal display device for monochrome display, as well as a liquid crystal display device capable of color display.

Moreover, although a liquid crystal display device is shown in the above preferred embodiments 1 and 2, the present invention can be applied to other types of display devices than a liquid crystal type, which use a backlight device.

While preferred embodiments of the present invention have been described above, it is to be understood that variations and modifications will be apparent to those skilled in the art without departing the scope and spirit of the present invention. The scope of the present invention, therefore, is to be determined solely by the following claims.

1-10. (canceled)

11. A lighting device for a display device, comprising:
a light source; and
a chassis arranged to cover said light source, wherein:
said chassis includes one of a groove section and an opening section located directly below said light source; and
said one of a groove section and an opening section has a relatively small width at an area directly below a low voltage area of said light source, compared to at an area directly below a high voltage area of said light source.

12. A lighting device for a display device, as in claim 11, wherein:
said light source has a linear portion; and
said one of a groove section and an opening section is arranged to extend along the linear portion of said light source.

13. A lighting device for a display device, as in claim 11, wherein said one of a groove section and an opening section has a width that decreases continuously and gradually from the area directly below the high voltage area of said light source toward the area directly below the low voltage area.

14. A lighting device for a display device, as in claim 11, wherein said one of a groove section and an opening section has a width that decreases step-by-step and gradually from the area directly below the high voltage area of said light source toward the area directly below the low voltage area.

15. A lighting device for a display device, as in claim 11, wherein an inverter circuit is connected to an end portion of said light source corresponding to said high voltage area.

16. A lighting device for a display device, as in claim 11, wherein said light source is arranged to be driven by pulse-width modulation.

17. A lighting device for a display device, as in claim 11, wherein said chassis includes a metallic plate.

18. A lighting device for a display device, as in claim 11, wherein said chassis includes an opening section located directly below said light source, a light-blocking resin sheet is attached to said chassis so as to cover said opening section.

19. A display device comprising:
a lighting device for a display device, as in claim 11; and
a display panel arranged to provide display by use of light from said lighting device for a display device.

20. A display device as in claim 19, wherein said display panel is a liquid crystal panel that uses liquid crystal.
